(19) United States
(12) Patent Application Publication
(10) Pub. No.: US 2024/0304178 A1
(43) Pub. Date: Sep. 12, 2024

(54) USING TEXT-INJECTION TO RECOGNIZE SPEECH WITHOUT TRANSCRIPTION

(71) Applicant: Google LLC, Mountain View, CA (US)

(72) Inventors: Andrew M Rosenberg, Brooklyn, NY (US); Yacob Yochai Blau, Mountain View, CA (US); Bhuvana Ramabhadran, Mt. Kisco, NY (US); Genady Beryozkin, Mountain View, CA (US); Gary Wang, Mountain View, CA (US); Zhehuai Chen, Edgewater, NJ (US); Rohan Agrawal, Mountain View, CA (US); Parisa Haghani, Mountain View, CA (US)

(73) Assignee: Google LLC, Mountain View, CA (US)

(21) Appl. No.: 18/439,630

(22) Filed: Feb. 12, 2024

Related U.S. Application Data
(60) Provisional application No. 63/487,821, filed on Mar. 1, 2023.

(51) Int. Cl. G10L 15/06; G10L 15/22; G10L 15/26

(52) U.S. Cl. CPC G10L 15/063; G10L 15/22; G10L 15/26

(57) ABSTRACT

A method includes receiving training data including transcribed speech utterances spoken in a general domain, modified speech utterances in a target domain, and unspoken textual utterances corresponding to the transcriptions of the modified speech utterances in the target domain. The modified speech utterances include utterances spoken in the target domain that have been modified to obfuscate one or more classes of sensitive information recited in the utterances. The method also includes generating a corresponding alignment output for each unspoken textual utterance of the received training data using an alignment model. The method also includes training a speech recognition model on the alignment outputs generated for the corresponding to the unspoken textual utterances, the un-transcribed speech utterances, and the transcribed speech utterances to teach the speech recognition model to learn to recognize speech in the target domain and phrases within the one or more classes of sensitive information.

### CROSS REFERENCE TO RELATED APPLICATIONS

This U.S. patent application claims priority under 35 U.S.C. § 119(e) to U.S. Provisional Application No. 63/487,821, filed on Mar. 1, 2023. The disclosure of this prior application is considered part of the disclosure of this application and is hereby incorporated by reference in its entirety.

### TECHNICAL FIELD

This disclosure relates to using text-injection to recognize speech without transcriptions.

### BACKGROUND

Automatic speech recognition (ASR), the process of taking an audio input and transcribing it into text, has greatly been an important technology that is used in mobile devices and other devices. In general, automatic speech recognition attempts to provide accurate transcriptions of what a person has said by taking an audio input (e.g., speech utterance) and transcribing the audio input into text. Modern ASR models continue to improve in both accuracy (e.g. a low word error rate (WER)) and latency (e.g., delay between the user speaking and the transcription) based on the ongoing development of deep neural networks. However, one challenge in developing deep learning-based ASR models is that parameters of the ASR models tend to over fit the training data, thereby resulting in the ASR models having difficulties generalizing unseen data when the training data is not extensive enough. Yet, this challenge is further complicated when training ASR models on low-resource speech domains that include an insufficient amount (or even zero) of transcribed speech training data.

### SUMMARY

One aspect of the disclosure provides a computer-implemented method that when executed on data processing hardware causes the data processing hardware to perform operations for training a speech recognition model using text-injection. The operations include receiving training data including transcribed speech utterances spoken in a general domain, modified speech utterances in a target domain that have been modified to obfuscate one or more classes of sensitive information recited in the utterances, and unspoken textual utterances corresponding to the transcriptions of the modified speech utterances in the target domain. Each transcribed utterance is paired with a corresponding transcription. Each modified speech utterance is paired with a corresponding transcription that redacts the sensitive information obfuscated from the modified speech utterance. The unspoken textual utterances include fake random data inserted into redacted portions of the transcriptions of the modified speech utterances where the sensitive information recited in the modified speech utterance has been redacted. The operations also include generating a corresponding alignment output for each unspoken textual utterance of the received training data using an alignment model. The operations also include training a speech recognition model on the alignment outputs generated for the unspoken textual utterances, the modified speech utterances, and the transcribed speech utterances to teach the speech recognition model to learn to recognize speech in the target domain and phrases within the one or more classes of sensitive information.

Implementations of the disclosure may include one or more of the following optional features. In some implementations, the one or more classes of sensitive information includes at least one of personable identifiable information, protected health information, or dates. In some examples, the redacted portions of the transcriptions of the modified speech utterances are tagged with a class identifier identifying the class of sensitive information that has been redacted. In these examples, the fake random data inserted into each redacted portion of the transcriptions of the modified speech utterances may be associated with the class of sensitive information identified by the class identifier at the redacted portion. The transcribed speech utterances in the general domain may include a greater number of hours of speech than the modified speech utterances.

In some implementations, the speech recognition model includes an audio encoder and a decoder. The audio encoder includes a stack of self-attention layers each including a multi-headed self-attention mechanism. Here, the training data may further include un-transcribed speech utterances spoken in the general domain. Each un-transcribed speech utterance not paired with any corresponding transcription. In these implementations, training the speech recognition model includes: for each un-transcribed speech utterance, generating a corresponding encoded representation of the un-transcribed speech utterance and training the audio encoder on a contrastive loss applied on the corresponding encoded representation of the un-transcribed speech utterance; for each alignment output, generating a corresponding encoded representation of the alignment output and training the audio encoder on a contrastive loss applied on the corresponding encoded representation of the alignment output; and, for each transcribed speech utterance, generating a corresponding encoded representation of the transcribed speech utterance and training the audio encoder on a contrastive loss applied on the corresponding encoded representation of the transcribed speech utterance. The decoder may include one of a Connection Temporal Classification (CTC) decoder, a Listen Attend Spell (LAS) decoder, or Recurrent Neural Network-Transducer (RNN-T) decoder. In some examples, generating the corresponding alignment output for each unspoken textual utterance of the received training data includes extracting an initial textual representation from the unspoken textual utterance, predicting a text chunk duration for each text chunk in the unspoken textual utterance, and upsampling the initial textual representation using the predicted text chunk duration for each text chunk in the unspoken textual utterance.

Another aspect of the disclosure provides a system that includes data processing hardware and memory hardware storing instructions that when executed on the data processing hardware causes the data processing hardware to perform operations. The operations include receiving training data including transcribed speech utterances spoken in a general domain, modified speech utterances in a target domain that have been modified to obfuscate one or more classes of sensitive information recited in the utterances, and unspoken textual utterances corresponding to the transcriptions of the modified speech utterances in the target domain. Each transcribed utterance is paired with a corresponding transcription. Each modified speech utterance is paired with a corresponding transcription that redacts the sensitive information obfuscated from the modified speech utterance. The unspoken textual utterances include fake random data inserted into redacted portions of the transcriptions of the modified speech utterances where the sensitive information recited in the modified speech utterance has been redacted. The operations also include generating a corresponding alignment output for each unspoken textual utterance of the received training data using an alignment model. The operations also include training a speech recognition model on the alignment outputs generated for the unspoken textual utterances, the modified speech utterances, and the transcribed speech utterances to teach the speech recognition model to learn to recognize speech in the target domain and phrases within the one or more classes of sensitive information.

Implementations of the disclosure may include one or more of the following optional features. In some implementations, the one or more classes of sensitive information includes at least one of personable identifiable information, protected health information, or dates. In some examples, the redacted portions of the transcriptions of the modified speech utterances are tagged with a class identifier identifying the class of sensitive information that has been redacted. In these examples, the fake random data inserted into each redacted portion of the transcriptions of the modified speech utterances may be associated with the class of sensitive information identified by the class identifier at the redacted portion. The transcribed speech utterances in the general domain may include a greater number of hours of speech than the modified speech utterances.

In some implementations, the speech recognition model includes an audio encoder and a decoder. The audio encoder includes a stack of self-attention layers each including a multi-headed self-attention mechanism. Here, the training data may further include un-transcribed speech utterances spoken in the general domain. Each un-transcribed speech utterance not paired with any corresponding transcription. In these implementations, training the speech recognition model includes: for each un-transcribed speech utterance, generating a corresponding encoded representation of the un-transcribed speech utterance and training the audio encoder on a contrastive loss applied on the corresponding encoded representation of the un-transcribed speech utterance; for each alignment output, generating a corresponding encoded representation of the alignment output and training the audio encoder on a contrastive loss applied on the corresponding encoded representation of the alignment output; and, for each transcribed speech utterance, generating a corresponding encoded representation of the transcribed speech utterance and training the audio encoder on a contrastive loss applied on the corresponding encoded representation of the transcribed speech utterance. The decoder may include one of a Connection Temporal Classification (CTC) decoder, a Listen Attend Spell (LAS) decoder, or Recurrent Neural Network-Transducer (RNN-T) decoder. In some examples, generating the corresponding alignment output for each unspoken textual utterance of the received training data includes extracting an initial textual representation from the unspoken textual utterance, predicting a text chunk duration for each text chunk in the unspoken textual utterance, and upsampling the initial textual representation using the predicted text chunk duration for each text chunk in the unspoken textual utterance.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of an example speech recognition model.

FIGS. 3A-3C are schematic views of an example training process for training an audio encoder of the example speech recognition model of FIG. 2.

FIG. 4 is a schematic view of an alignment model used during the example training process for training the audio encoder of the speech recognition model in FIGS. 3A-3C.

FIG. 5 is a schematic view of an example training data generation process that generates modified speech utterances and unspoken textual utterances.

FIG. 6 is a flowchart of an example arrangement of operations for a computer-implemented method of training a speech recognition model using text-injection.

FIG. 7 is a schematic view of an example computing device that may be used to implement the systems and methods described herein.

Like reference symbols in the various drawings indicate like elements.

### DETAILED DESCRIPTION

One challenge in developing deep learning-based ASR models is that parameters of the ASR models tend to over fit the training data, thereby resulting in the ASR models having difficulties generalizing unseen data when the training data is not extensive enough. Thus, training the ASR models on larger training datasets improves the accuracy of the ASR model. For instance, the use of machine learning or other statistical methods can train ASR models on training data sets that include upwards of 10,000 hours of transcribed speech. Yet, performance of ASR models suffers when a domain associated with the training data is distinct from a domain that the ASR model receives during inference. For example, training an ASR model on transcribed speech on a domain associated with video meetings would be less effective in recognizing speech related to speech in a domain associated with healthcare.

In some scenarios, speech related to certain domains includes private and/or sensitive information such as names of people, dates, or other personal identifiers. For various ethical and legal reasons, this sensitive information may not be directly used to train ASR models. However, simply not training ASR models on this sensitive information results in ASR models having lower recognition accuracy of sensitive information during inference. One current approach includes de-identification, a process that redacts or eliminates personally identifiable information (PII) and other sensitive information from training data. For instance, the process may replace an audio segment that includes sensitive information with silence audio data and/or remove text representing sensitive information. In some instances, speech utterances are shorter (e.g., call-center applications), and thus, the de-identification process may eliminate training utterances entirely. Consequently, simply eliminating or redacting training data that includes sensitive information causes ASR models to have poor performance on similar sensitive information received during inference. Another approach includes replacing portions of training data that include sensitive information with synthesized speech. The synthesized speech may include the sensitive information or include information similar to the sensitive information. Yet, using synthetic speech in place of training data that includes sensitive information has several drawbacks. Namely, splicing synthetic speech into speech recordings that include sensitive information to get natural sounding training utterances is challenging and error prone. Moreover, even though state-of-the-art text-to-speech (TTS) models produce realistic sounding speech, training ASR models on synthetic speech is not as beneficial as training ASR models on human speech.

Accordingly, implementations herein are directed towards methods and systems of a training process that trains a speech recognition model using text-injection with unspoken textual utterances that include redacted information. The training process includes receiving training data that includes transcribed speech utterances spoken in a general domain, modified speech utterances in a target domain, and unspoken textual utterances. Each transcribed speech utterance is paired with a corresponding transcription. The modified speech utterances include utterances spoken in the target domain that have been modified to obfuscate one or more classes of sensitive information recited in the utterances. Moreover, each modified speech utterance is paired with a corresponding transcription that redacts the sensitive information obfuscated from the modified speech utterance. The unspoken textual utterances correspond to the transcriptions of the modified speech utterances in the target domain. The unspoken textual utterances include fake random data inserted into redacted portions of the transcriptions of the modified speech utterances where the sensitive information recited in the modified speech utterance has been redacted. The training process uses an alignment model to generate a corresponding alignment output for each unspoken textual utterance of the received training data. The training process also trains a speech recognition model on the alignment outputs, the modified speech utterances, and the transcribed speech utterances to teach the speech recognition model to learn to recognize speech in the target domain and phrases within the one or more classes of sensitive information. Notably, the training process trains the speech recognition model to recognize phrases within the one or more classes of sensitive information without directly using any of the sensitive information redacted from the modified speech utterances to train the speech recognition model.

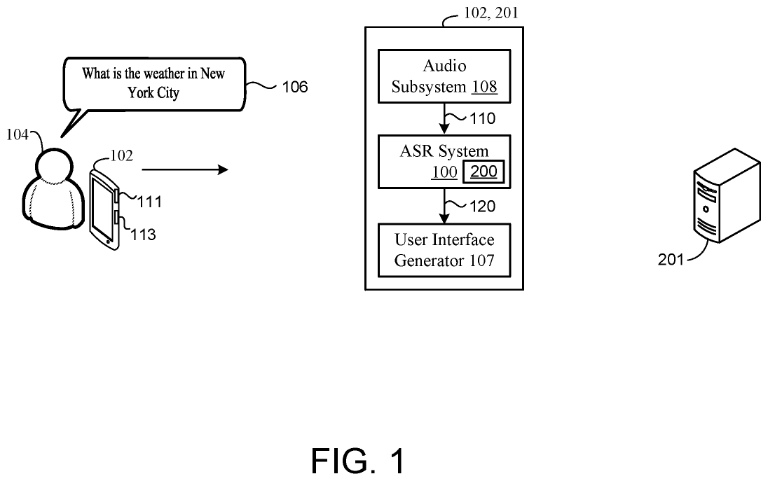

FIG. 1 illustrates an automated speech recognition (ASR) system 100 implementing an ASR model 200 that resides on a user device 102 of a user 104 and/or on a remote computing device 201 (e.g., one or more servers of a distributed system executing in a cloud-computing environment) in communication with the user device 102. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart speaker/display, a smart appliance, an automotive infotainment system, or an Internet-of-Things (IoT) device, and is equipped with data processing hardware 111 and memory hardware 113.

The user device 102 includes an audio subsystem 108 configured to receive an utterance 106 spoken by the user 104 (e.g., the user device 102 may include one or more microphones for recording the spoken utterance 106) and convert the utterance 106 into a corresponding digital format associated with input acoustic frames 110 capable of being processed by the ASR system 100. In the example shown, the user speaks a respective utterance 106 in a natural language of English for the phrase “What is the weather in New York City?” and the audio subsystem 108 converts the utterance 106 into corresponding acoustic frames 110 for input to the ASR system 100. Thereafter, the ASR model 200 receives, as input, the acoustic frames 110 corresponding to the utterance 106, and generates/predicts, as output, a corresponding transcription 120 (e.g., recognition result/hypothesis) of the utterance 106. In the example shown, the user device 102 and/or the remote computing device 201 also executes a user interface generator 107 configured to present a representation of the transcription 120 of the utterance 106 to the user 104 of the user device 102. In some configurations, the transcription 120 output from the ASR system 100 is processed, e.g., by a natural language understanding (NLU) module executing on the user device 102 or the remote computing device 201, to execute a user command. Additionally or alternatively, a text-to-speech system (e.g., executing on any combination of the user device 102 or the remote computing device 201) may convert the transcription into synthesized speech for audible output by another device. For instance, the original utterance 106 may correspond to a message the user 104 is sending to a friend in which the transcription 120 is converted to synthesized speech for audible output to the friend to listen to the message conveyed in the original utterance 106.

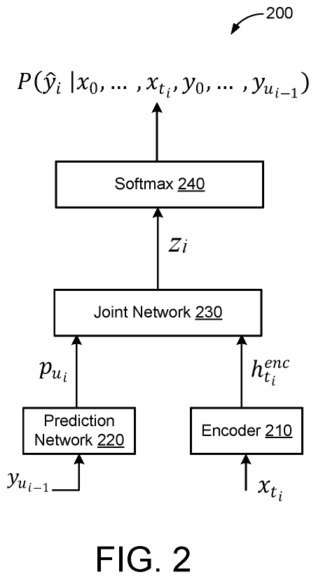

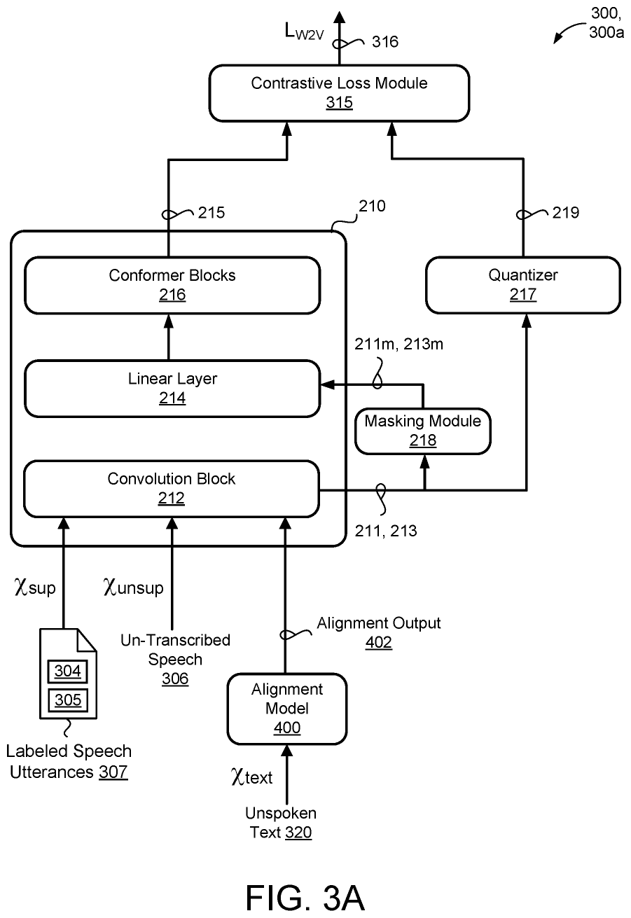

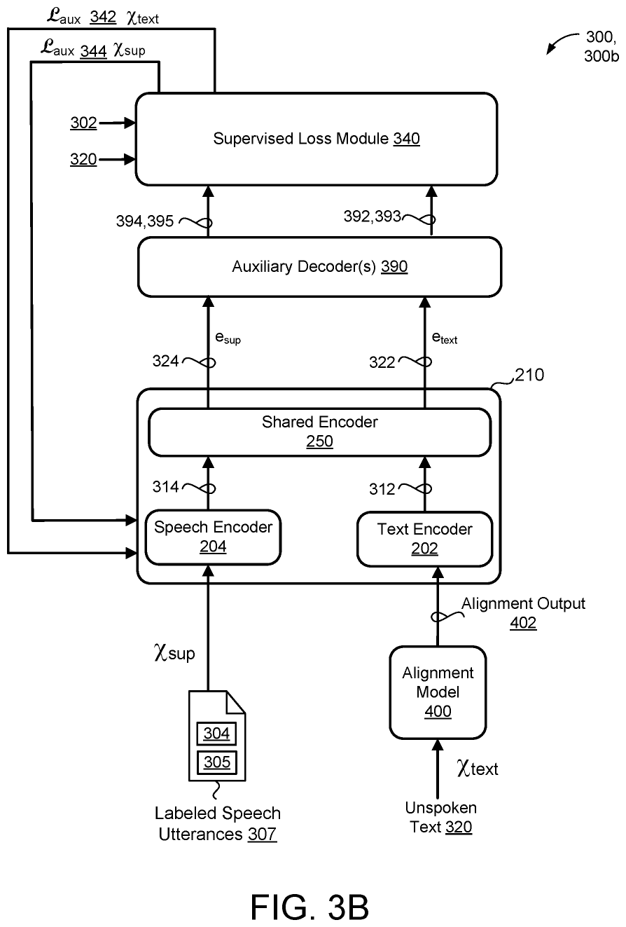

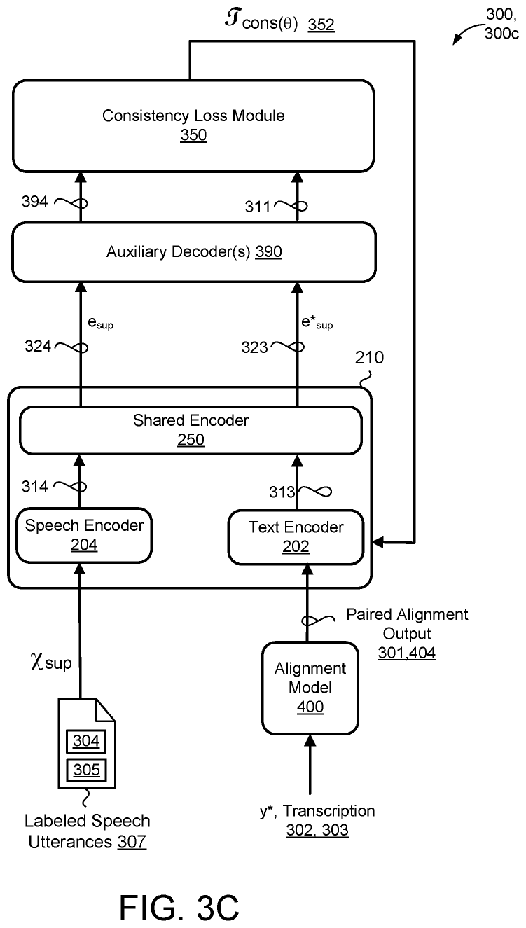

Referring to FIG. 2, an example ASR model 200 may include a Recurrent Neural Network-Transducer (RNN-T) model architecture which adheres to latency constraints associated with interactive applications. The use of the RNN-T model architecture is exemplary, and the frame alignment-based transducer model 200 may include other architectures such as transformer-transducer and conformer-transducer model architectures among others. The RNN-T model 200 provides a small computational footprint and utilizes less memory requirements than conventional ASR architectures, making the RNN-T model architecture suitable for performing speech recognition entirely on the user device 102 (e.g., no communication with a remote server is required). The RNN-T model 200 includes an encoder network 210, a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the encoder reads a sequence of d-dimensional feature vectors (e.g., acoustic frames 110 (FIG. 1)) x=(x₁, x₂, . . . , x_{T}), where xₜ∈ [symbol] _{d}, and produces at each output step a higher-order feature representation. This higher-order feature representation is denoted as h₁^{enc}, . . . , h_{T}^{enc}. In some examples, the encoder network 210 includes a dual encoder framework that has a text encoder 202 and a speech encoder 204 (FIGS. 3B and 3C).

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(yᵢ|xₜ_{ᵢ}, y₀, . . . , yᵤ_{ᵢ₋₁}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics but also on the sequence of labels output so far. The RNN-T model 200 does assume an output symbol is independent of future acoustic frames 110, which allows the RNN-T model to be employed in a streaming fashion, the non-streaming fashion, or some combination thereof.

In some examples, the encoder network (i.e., audio encoder) 210 of the RNN-T model 200 includes a stack of self-attention layers/blocks, such as conformer blocks. Here, each conformer block includes a series of multi-headed self attention, depth wise convolution and feed-forward layers. The prediction network 220 may have two 2,048-dimensional LSTM layers, each of which is also followed by a 640-dimensional projection layer. Alternatively, the prediction network 220 may include a stack of transformer or conformer blocks, or an embedding look-up table in lieu of LSTM layers. Finally, the joint network 230 may also have 640 hidden units. The Softmax layer 240 may be composed of a unified word piece or grapheme set that is generated using all unique word pieces or graphemes in a plurality of training data sets.

FIGS. 3A-3C illustrate an example training process 300 for training the ASR model 200 (FIG. 2). The training process 300 described herein describes training the audio encoder 210 of the ASR model 200, however, it is understood that the training process 300 may also include pre-training and/or fine-tuning of the audio encoder 210. Moreover, implementations described herein contemplate the training process 300 training the audio encoder 210 of the ASR model 200 without training the decoder (e.g., prediction network 220 and the joint network 230) of the ASR model 200. Yet, it is understood that the training process 300 may additionally or alternatively train other components of the ASR model 200 (e.g., prediction network 220 and/or joint network 230) jointly with the audio encoder 210.

The training process 300 may train the audio encoder 210 using available training data that includes a set of unspoken textual utterances (Xₜₑₓₜ) 320, a set of labeled speech utterances (Xₛᵤₚ) 307, and/or un-transcribed non-synthetic speech utterances (Xᵤₙₛᵤₚ) 306. The labeled speech utterances 307 may include transcribed speech utterances 304 and/or modified speech utterances 305. Each labeled speech utterance 307 is paired with a corresponding transcription (e.g., ground-truth label) 302, 303. In particular, each transcribed speech utterance 304 is paired with a first transcription 302, and each modified speech utterance 305 is paired with a second transcription (e.g., modified transcription) 303. The transcribed speech utterances 304 include utterances spoken in a general domain. In contrast, the modified speech utterances 305 include utterances spoken in a target domain different from the general domain. For instance, the general domain may include speech from a video library and the corresponding captions and the target domain may be speech associated with a healthcare domain, finance domain, or any other speech-related domain that includes personal and/or sensitive information. Here, the speech from the video library may only include some (or zero) speech associated with the healthcare domain. Thus, the transcribed speech utterances 304 in the general domain may include a greater number of hours of speech than the modified speech utterances 305. The modified speech utterances 305 are modified to obfuscate one or more classes of sensitive information recited in the utterances. As such, the second transcriptions 303 that are paired with the modified speech utterances 305 redact the sensitive information obfuscated from the modified speech utterances 305. In some examples, the training process 300 uses the transcribed speech utterances 304 and the modified speech utterances 305 from the labeled speech utterances 307 to train the audio encoder 210. In other examples, the training process 300 only uses the transcribed speech utterances 304 (e.g., and not the modified speech utterances 305) from the labeled speech utterances 307 to train the audio encoder 210.

Each unspoken textual utterance 320 includes text-only data (i.e., unpaired data) such that each unspoken textual utterance 320 is not paired with any corresponding spoken audio representation (i.e., speech) of the utterance. The unspoken textual utterance 320 may include any sequence of text chunks including words, word-pieces, phonemes, and/or graphemes. The unspoken textual utterances 320 may correspond to the modified speech utterances 305. Since the unspoken textual utterances 320 is not paired with any corresponding transcriptions, the training process 300 does not use the modified speech utterances 305 and the unspoken textual utterances 320 together when training the audio encoder 210. Simply put, the training process uses the text-only data of the unspoken textual utterances 320 when using the unspoken textual utterances 320 to train the audio encoder 210 without using the corresponding audio data of the modified speech utterances 305. Each un-transcribed non-synthetic speech utterance 306 (also referred to as simply “un-transcribed speech utterance 306”) is spoken in the general domain and includes audio-only data (i.e., unpaired data) such that the un-transcribed speech utterance 306 is not paired with any corresponding transcription.

For simplicity, the training process 300 includes a contrastive self-supervised loss part 300a (FIG. 3A), a supervised loss part 300b (FIG. 3B), and a consistency regularization part 300c (FIG. 3C). The training process 300 pre-trains the audio encoder 210 on a total loss (Lₜₜₛ₄ₚᵣₑₜᵣₐᵢₙ₂) based on: contrastive losses (L_{w2x}) 316 derived using the contrastive self-supervised loss part 300a from the unspoken training text utterances (Xₜₑₓₜ) 320, the corpus of labeled speech utterances (Xₛᵤₚ) 307, and the un-transcribed non-synthetic speech utterances (Xᵤₙₛᵤₚ) 306; supervised losses (Lₐᵤₓ) 342, 344 derived using the supervised loss part 300b from the unspoken training text utterances (Xₜₑₓₜ) 320 and the labeled speech utterances (Xₛᵤₚ) 307; and consistency losses ( [symbol] _{cons}(θ)) 352 derived using the consistency regularization part 300c.

Referring to FIG. 3A, the contrastive self-supervised loss part 300a of the training process 300 may employ an alignment model 400 that is configured to generate, at each of a plurality of output steps, alignment outputs (i.e., textual representation) 402 for each of a plurality of unspoken training text utterances 320. The unspoken textual utterances 320 includes unspoken text that is text-only data, i.e., unpaired data, such that each unspoken textual utterance (Xₜₑₓₜ) 320 is not paired with any synthesized or non-synthesized speech. Accordingly, the alignment model 400 generates a corresponding alignment output 402 for each of the unspoken textual utterances 320.

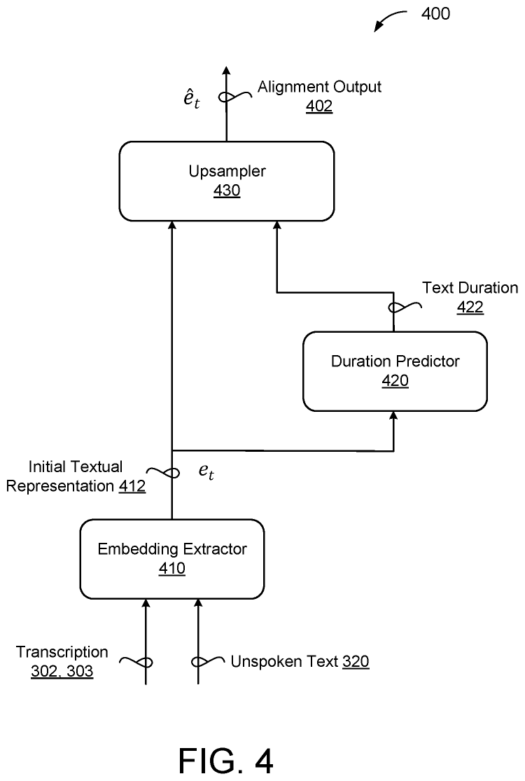

Referring now to FIG. 4, in some examples, the alignment model 400 includes an embedding extractor 410, duration predictor 420, and an upsampler 430. The embedding extractor 410 receives the unspoken textual utterance 320 that includes a sequence of text chunks including words, word-pieces, phonemes, and/or graphemes and extracts a corresponding initial textual representation (eₜ) 412. The initial textual representation 412 includes embedding lexical information from the unspoken textual utterance 320. Additionally or alternatively, the embedding extractor 410 may receive a transcription 302 corresponding to a transcribed non-synthetic speech utterance 304 (FIG. 3C). The duration predictor 420 receives the initial textual representation 412 from the embedding extractor 410 and predicts a corresponding text chunk duration (i.e., word, word-piece, phoneme, and/or grapheme duration) 422. The text chunk duration 422 indicates a duration the corresponding text chunk would be spoken if a human (or text-to-speech system) spoke the unspoken textual utterance 320. For example, the unspoken textual utterance 320 may include a sequence of phonemes and the duration predictor 420 predicts a phoneme duration 422 for each phoneme in the sequence of phonemes. In this example, the duration predictor 420 predicts the phoneme duration 422 by predicting a probability of non-zero duration for each phoneme and predicting a probability of continuous phoneme duration for each phoneme. As the sequence of phonemes includes regular phonemes, silences between word boundaries, and punctuation marks, only the regular phonemes are associated with non-zero duration while the silences and punctuation marks are generally associated with the continuous phoneme duration. Accordingly, the duration predictor 420 may use a sigmoid activation following a first one of two independent activations to predict the probability of non-zero duration and use a soft plus activation following a second one of the two independent projections to predict the continuous text chunk duration 422 for each text chunk. The duration predictor 420 determines, for each text chunk, whether the probability of non-zero duration is less than a threshold value, and when the probability of non-zero duration is less than the threshold value, a multiplier may zero-out the continuous text chunk duration 422 predicted by the softplus activation for the corresponding text chunk. Otherwise, when the probability of non-zero duration is not less than the threshold value, the predicted text chunk duration 422 may be set equal to the continuous phoneme duration predicted by the softplus activation.

The upsampler 430 receives, for each unspoken textual utterance 320, the corresponding initial textual representation 412 and the predicted text chunk duration 422, and generates an alignment output (êₜ) 402 having a number of frames by upsampling the initial textual representation 412 using the corresponding predicted text chunk duration 422. Here, the alignment output 402 represents an aligned speech-text representation. In some examples, the alignment model 400 sends the alignment output 402 to a text encoder 202 of the audio encoder 210 (FIGS. 3B and 3C). In other examples (not shown), the alignment model 400 sends the alignment output 402 to a shared encoder 250 (e.g., bypassing the text encoder 202) of the audio encoder 210 (FIGS. 3B and 3C). In these other examples, the alignment output 402 serves as the encoded textual representation 312 such that the shared encoder 250 may receive the alignment output 402 directly from the alignment model 400. In yet other examples, paired training data is available and the upsampler 430 generates the alignment output 402 as follows:

$${\hat{e}}_{t} = {θ}_{R e f i n e r} ( Resample ( {e}_{t} , {Align}_{R N N - T} ( {e}_{s} , t ) ) ) \qquad ( 1 )$$

Here, the upsampler 430 includes resampler and refiner layers that align the initial textual embedding 412 to align with a corresponding encoded audio representation 314 (FIGS. 3B and 3C) directly. However, when paired training data is not available, the upsampler 430 generates the alignment output 402 as follows:

$${\hat{e}}_{t} = {θ}_{Refiner} ( Resample ( {e}_{t} , {θ}_{duration} ( {e}_{t} ) ) ) \qquad ( 2 )$$

In particular, the number of frames of the alignment output 402 indicates a predicted speech duration of the unspoken textual utterance 320. Stated differently, the number of frames of the alignment output 402 maps (i.e., aligns) the sequence of text chunks of the unspoken textual utterance 320 to speech frames. Here, the upsampler 430 includes resampler and refiner layers that replicate the initial textual embedding 412 to match the predicted text chunk duration 422 (i.e., speech duration). As such, the alignment output 402 includes a textual representation of the unspoken textual utterance 320 having a timing component that aligns with how a human would speak the unspoken textual utterance 320.

Notably, in most instances, a text-to-speech (TTS) system generates an audible output to give the unspoken textual utterance 320 the timing component of human speech such that a training process may use the audible output from the TTS system (i.e., synthetic speech) to train the audio encoder 210. However, the alignment model 400 advantageously generates the alignment output 402 thereby mapping the sequence of text chunks to speech frames directly. As such, the training process 300 does not require any TTS system to generate synthetic speech from the unspoken textual utterances 320 to train the audio encoder 210. That is, neither the training process 300 nor the alignment model 400 converts the unspoken textual utterance 320 into synthetic speech, but rather generates alignment outputs 402 (i.e., text alignments).

Referring back to FIG. 3A, in some implementations, the audio encoder 210 includes a speech encoder 204 and a text encoder 202, described in more detail with reference to FIGS. 3B and 3C. In the example shown, the audio encoder 210 (alternatively the speech encoder 204 or the text encoder 202 (FIGS. 3B and 3C)) includes a Conformer encoder including a stack of Conformer blocks each of which includes a stack of multi-headed self-attention, depth wise convolution, and feed-forward layers. Alternatively, the audio encoder 210 may include another type of encoder having a stack of multi-head self-attention layers/blocks, such as a transformer or performer encoder. The Conformer encoder 210 can naturally be split into a feature encoder, including a convolution subsampling block 212, and a context network, including a linear layer 214 and a stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each labeled speech utterance 307 and each un-transcribed non-synthetic speech utterance 306, and generates, as output, for each of a plurality of output steps, an encoded audio feature 211 that corresponds to a respective one of labeled speech utterances 307 or a respective one of the un-transcribed non-synthetic speech utterances 306. The convolution subsampling block 212 may receive, as input, each alignment output 402 generated by the alignment model 400 from the unspoken textual utterances 320 and generate, as output, for each of the plurality of output steps, an encoded textual feature 213 that corresponds to a respective one of the alignment outputs 402.

The encoded audio and textual features 211, 213 (i.e., interchangeably referred to as “encoded features 211, 213”) output from the convolution subsampling block 212 may be fed to a masking module 218 where some of the encoded features 211, 213 are randomly chosen and replaced with a trained feature vector shared between all masked time steps to provide corresponding masked encoded audio features 211, 211m and masked encoded textual features 213, 213m. In some examples, the masking module 218 masks the randomly chosen encoded features 211, 213 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 216 of the context network receive the masked encoded features 211m, 213m (or encoded features 211, 213 not chosen by the masking module 218) and outputs corresponding contrastive context vectors (i.e., encoded representation) 215 from masked encoded features 211m, 213m. Moreover, a quantizer 217 receives the encoded features 211, 213 as input, and generates quantized vectors (i.e., target context vectors) 219 as output. Thereafter, a contrastive loss module 315 derives a contrastive loss (L_{w2v}) 316 between the contrastive context vectors 215 at the masked positions and the target context vectors 219 as follows.

$${ℒ}_{w 2 v} = - log \frac{exp ( sim ( {c}_{t} , {q}_{t} ) / k )}{{\sum }_{\tilde{q} - {Q}_{t}} exp ( sim ( {c}_{t} , \tilde{q} ) / k )} \qquad ( 3 )$$

where cₜ is contrastive context vector 215 centered over a masked output step (i.e., time step) t and qₜ represents a target context vector 219 at the output step t in a set of K+1 candidate target context vectors 219 which includes qₜ and K distractors. Distractors may be uniformly sampled from other masked output steps of the same utterance.

The contrastive loss 316 is optimized between the contrastive context vectors 215 at the masked positions and the target context vectors 219. After the audio encoder 210 converges on the un-transcribed non-synthetic speech utterances 306, the training procedure is repeated on both the alignment outputs 402 corresponding to the unspoken textual utterance 320 and the labeled speech utterance 307. Thus, the contrastive loss 316 (L_{w2v}) is optimized for both real/human (non-synthetic) and unspoken textual utterances 320 represented by alignment outputs 402, with additional auxiliary losses derived from the labeled speech utterances 307 and the alignment outputs 402 as described in greater detail below with reference to FIG. 3B. Accordingly, the contrastive self-supervised loss part 300a of the training process 300 trains the audio encoder 210 using the contrastive loss 316 derived from the corresponding encoded features 211, 213 associated with each alignment output 402, each labeled speech utterances 307, and each un-transcribed non-synthetic speech utterance 306 provided as input to the audio encoder 210. Training the audio encoder 210 may include updating parameters of the audio encoder 210 based on the contrastive losses 316.

Referring to FIG. 3B, the supervised loss part 300b of the training process 300 is configured to inject lexical information into the audio encoder 210 during training based on supervised loss terms 342, 344 derived from the transcribed non-synthetic speech utterances and the alignment outputs 402 corresponding to unspoken textual utterances 320 output by the alignment model 400. Notably, the supervised loss part 300b leverages one or more auxiliary decoders 390 for generating the supervised loss terms 342, 344. The auxiliary decoders 390 may include Connectionist Temporal Classification (CTC) decoders, Listen Attend Spell (LAS) decoders, or RNN-T decoders. These auxiliary decoders 390 may include at least one of a phoneme decoder configured to decode a sequence of phonemes or a wordpiece decoder configured to decode a sequence of word pieces. The auxiliary decoders 390 could also include a grapheme decoder configured to decode a sequence of graphemes.

During the supervised loss part 300b, the text encoder 202 of the audio encoder is configured to receive alignment outputs 402 (i.e., text embeddings) from the alignment model 400 and the speech encoder 204 is configured to receive the labeled speech utterances 307. That is, the text encoder 202 of the audio encoder 210 generates encoded textual representations 312 for alignment outputs 402 (e.g., corresponding to an unspoken textual utterance 320) and the speech encoder 204 of the audio encoder 210 generates encoded audio representations 314 for speech inputs (i.e., labeled speech utterances 307). Here, the encoded textual representations 312 and the encoded audio representations 314 may not both be compatible with the auxiliary decoders 390. Thus, the audio encoder 210 may also include a shared encoder 250 that receives the encoded textual representations 312 as input, and generates a first encoded shared representation 322 (eₜₑₓₜ) as output. Moreover, the shared encoder 250 receives the encoded audio representations 314 as input, and generates a second encoded shared representation (eₛᵤₚ) 324 as output. Accordingly, the shared encoder 250 generates the first and second encoded shared representations 322, 324 into a shared latent representation space compatible with the auxiliary decoder 390.

In particular, the shared encoder 250 receives, as input, each encoded textual representation 312 that corresponds to the alignment output 402 generated from the unspoken textual utterance 320 and generates, as output, for each of the plurality of output steps, the first encoded shared representation (eₜₑₓₜ) 322 that corresponds to the alignment output 402 at the corresponding output step. The auxiliary decoder 390 including the phoneme decoder, wordpiece decoder, or the byte decoder receives, as input, each first encoded shared representation 322 output from the shared encoder 250 and generates, as output, a first probability distribution 392 over possible speech recognition hypotheses for the corresponding alignment output 402 at the corresponding time step. In some examples, the first probability distribution 392 over possible speech recognition hypotheses includes one of possible phoneme labels, possible word piece labels, or possible grapheme labels. Thereafter, a supervised loss module 340 may determine an alignment output loss term 342 based on the first probability distribution 392 over possible speech recognition hypotheses for the alignment output 402 corresponding to the unspoken textual utterance 320. Here, the corresponding unspoken textual utterance 320 in which the alignment output 402 is generated from, also serves as a ground-truth transcription. The supervised loss part 300b may train the audio encoder 210 on the alignment output loss term 342 by updating parameters of the audio encoder 210 based on the alignment output loss term 342.

Similarly, during the supervised loss part 300b, the shared encoder 250 receives, as input, each transcribed encoded audio representation 314 that corresponds to the labeled speech utterance 307 and generates, as output, for each of the plurality of output steps, a second encoded shared representation (eₛᵤₚ) 324 that corresponds to the labeled speech utterance 307 at the corresponding output step. The auxiliary decoder 390 including the phoneme decoder, the wordpiece decoder, or the byte decoder receives, as input, each second encoded shared representation 324 output from the shared encoder 250 and generates, as output, a second probability distribution 394 over possible non-synthetic speech recognition hypotheses for the corresponding labeled speech utterance 307 at the corresponding output step. In some examples, the second probability distribution 394 over possible non-synthetic speech recognition hypotheses includes the one of possible phoneme labels, the possible word piece labels, or the possible grapheme labels. Thereafter, the supervised loss module 340 may determine a non-synthetic speech loss term 344 based on the second probability distribution 394 over possible non-synthetic speech recognition hypotheses and the corresponding transcription 302, 303 paired with the labeled speech utterances 307. Here, the corresponding transcription 302, 303 serves as a ground-truth transcription and may include a sequence of target phonemes, target word pieces, and/or target graphemes. The supervised loss part 300b may train the audio encoder 210 on the non-synthetic speech loss term 344 by updating parameters of the audio encoder 210 based on the non-synthetic speech loss term 344.

In some implementations, the supervised loss part 300b of the training process 300 uses another auxiliary decoder 390 to generate a third probability distribution 393 over possible speech recognition hypotheses based on the first encoded shared representation (eₜₑₓₜ) 322 for the alignment output 402 at the corresponding output step, whereby the supervised loss module 340 may determine another alignment output loss term 342 based on the third probability distribution 393 and the unspoken textual utterance 320 corresponding to the alignment output 402. Here, the other auxiliary decoder 390 includes the other one of the phoneme decoder, word piece decoder, or the grapheme decoder and the third probability distribution 393 over possible speech recognition hypotheses includes the other one of the possible phoneme labels, the possible word piece labels, or the possible grapheme labels. In these implementations, the other auxiliary decoder 390 also generates a fourth probability distribution 395 over possible non-synthetic speech recognition hypotheses for the corresponding second encoded shared representation 324 at the corresponding output step, whereby the supervised loss module 340 may determine another non-synthetic speech loss term 344 based on the fourth probability distribution 395 and the corresponding transcription 302 that is paired with the transcribed non-synthetic speech representation 304. Here, the fourth probability distribution 395 over possible non-synthetic speech recognition hypotheses includes the other one of the possible phoneme labels, the possible word piece labels, or the possible grapheme labels. The supervised loss part 300b of the training process 300 may similarly the audio encoder 210 on the other alignment output loss term 342 and the other non-synthetic speech loss term 344.

The un-transcribed non-synthetic speech utterances 306 and the unspoken textual utterances 320 each correspond to “unpaired” training data whereby the contrastive loss (L_{w2v}) 316 derived from the unspoken textual utterances (Xₜₑₓₜ) 320 may be combined with the supervised loss [symbol] ₐᵤₓ associated with the alignment output loss term 342 to obtain an unspoken textual loss function, [symbol] ₜₑₓₜ, as follows.

$${𝒥}_{text} = {ℒ}_{w 2 v} ( x \vert {θ}_{e} ) + {ℒ}_{aux} ( y \vert x , {θ}_{e} , {θ}_{d} ) \qquad ( 4 )$$

Likewise, the contrastive loss (L_{w2v}) 316 derived from the un-transcribed non-synthetic speech utterances (Xᵤₙₛᵤₚ) 306 may be used to express an unsupervised speech loss function, [symbol] _{unsup_speech}, as follows.

$${𝒥}_{unsup \_ speech} = {𝒥}_{w 2 v} ( {x}^{*} \vert {θ}_{e} ) \qquad ( 5 )$$

During training of the audio encoder 210, the alignment outputs 402 and the un-transcribed non-synthetic utterances 306 may be separated or mixed within each batch. In order to force the audio encoder 210 to learn representations that are effective for both alignment outputs 402 corresponding to unspoken textual utterances 320 and non-synthetic (human/real) speech, the loss mask σ is applied when combining the loss functions [symbol] ₜₑₓₜ to obtain an unpaired data loss function, [symbol] _{unpaired}, as follows:

$${𝒥}_{unpaired} = {σ𝒥}_{text} + ( 1 - σ ) {𝒥}_{speech} \qquad ( 6 )$$

The labeled speech utterances 307 corresponds to “paired” and “supervised” training data whereby the derived contrastive loss L_{w2v} and the derived supervised loss [symbol] ₐᵤₓ associated with the non-synthetic speech loss term 344 may be combined to obtain a paired data loss function, [symbol] _{paired}, as follows:

$${𝒥}_{paired} = {ℒ}_{w 2 v} ( x \vert {θ}_{e} ) + {ℒ}_{aux} ( y \vert x , {θ}_{e} , {θ}_{d} ) \qquad ( 7 )$$

Referring to FIG. 3C, the consistency regularization part (i.e., modality matching part) 300c of the training process 300 is configured to promote the audio encoder 210 to learn consistent predictions between non-synthetic speech (e.g., real/human speech) and alignment outputs 402 corresponding to unspoken textual utterances 320 by generating a consistent loss term ( [symbol] _{cons}(θ)) 352 between training utterance pairs 301 that each include a corresponding one of the labeled speech utterances (Xₛᵤₚ) 307 and a paired alignment output 404 of the same utterance as the corresponding labeled speech utterance 307. As such, the labeled speech utterance 307 and the paired alignment output 404 of each training utterance pair 301 is associated with a same ground-truth transcription. In short, the consistent loss term 352 between the transcribed non-synthetic speech utterance 304 and paired alignment output 404 of the same training utterance provides an unsupervised training aspect by encouraging the audio encoder 210 to behave consistently regardless of whether the training utterance belongs to non-synthetic speech (i.e., speech training data) or the alignment output (i.e., text training data) and independent of supervised loss terms between the ground-truth transcription 302, 303 and each of: non-synthetic speech recognition hypotheses output by the auxiliary decoder 390; and speech recognition hypotheses output by the auxiliary decoder 390.

Similar to the alignment outputs 402 generated from the unspoken textual utterances 320 in FIG. 3B, the alignment model 400 may generate each paired alignment output 404 using the corresponding transcription 302, 303 that is paired with the labeled speech utterance 307. Here, the non-synthetic speech representation 304 is associated with paired alignment output 404 generated by the alignment model 400 mapping the unspoken textual utterance 320 into speech frames. During the consistency regularization part 300c, the text encoder 202 receives, as input, each paired alignment output 404 and generates, as output, for each of the plurality of output steps, an encoded textual representation 313 that corresponds to the paired alignment output 404 at the corresponding output step. The shared encoder 250 receives, as input, the encoded textual representation 313 and generates, as output, a first encoded shared representation (e*ₛᵤₚ) 323. The auxiliary decoder 390 including the phoneme decoder or the wordpiece decoder receives, as input, each first encoded shared representation 323 output from the shared encoder 250 and generates, as output, a first probability distribution 311 over possible speech recognition hypotheses for the corresponding paired alignment output 404 at the corresponding output step. In some examples, the first probability distribution 311 over possible speech recognition hypotheses includes one of possible phoneme labels or possible word piece labels.

Similarly, the speech encoder 204 receives, as input, each labeled speech utterance 307 as a sequence of features/vectors (e.g., mel-frequency spectrograms such as the acoustic frames 110 of FIG. 1) and generates, as output, for each of a plurality of output steps, a encoded audio representation 314 that corresponds to the labeled speech utterance 307 at the corresponding output step. The shared encoder 250 receives, as input, the encoded audio representation 314 and generates, as output, a second encoded shared representation (eₛᵤₚ) 324. The auxiliary decoder 390 including the phoneme decoder or the wordpiece decoder receives, as input, each second encoded shared representation 324 output from the shared encoder 250 and generates, as output, a second probability distribution 394 over possible non-synthetic speech recognition hypotheses for the corresponding labeled speech utterance at the corresponding time step. In some examples, the second probability distribution 394 over possible non-synthetic speech recognition hypotheses includes the one of the possible phoneme labels or the possible word piece labels.

With continued reference to FIG. 3C, the consistency regularization part 300c of the training process 300 further determines, at each of the plurality of time steps for each training utterance pair 301, the consistent loss term ( [symbol] _{cons}(θ)) 352 for the corresponding training utterance pair 301 based on the first probability distribution 311 over possible speech recognition hypotheses and the second probability distribution 394 over possible non-synthetic speech recognition hypotheses. For instance, the training process 300 may employ a consistency loss term module 350 configured to receive, at each time step, the corresponding non-synthetic speech and speech recognition results 311, 394 output by the auxiliary decoder 390, and determine the consistency loss term 352 for the corresponding training utterance pair 301 at the time step.

In some examples, the consistency regularization part 300c of the training process 300 determines the consistent loss term 352 based on a Kullback-Leibler divergence (D_{KL}) between the first probability distribution 311 over possible speech recognition hypotheses and the second probability distribution 394 over possible non-synthetic speech recognition hypotheses. The consistent loss term 352 based on D_{KL} may be expressed by the following equation:

$${𝒥}_{cons} ( θ ) = {𝒟}_{KL} ( {p}_{\tilde{θ}} ( y \vert x ) ‖ {p}_{θ} ( y \vert \hat{x} ) ) \qquad ( 8 )$$

Here, the consistent loss term 352 determined for the training utterance pair 301 at each time step provides an “unsupervised” loss term that is independent of the accuracy of the auxiliary decoder 390 (e.g., independent of the supervised loss terms 342, 344 of FIG. 3B), and thus, may be employed to update parameters of the audio encoder 210 for promoting consistency between non-synthetic speech representations and alignment outputs of the same utterances. In batch training, the consistent loss term 352 may correspond to an average loss term obtained for the batch. In other words, the consistent loss term 352 permits the audio encoder 210 to learn to behave the same, e.g., make consistent encoded representation predictions on both non-synthetic speech (e.g., real/human speech) and alignment outputs of a same training utterance, regardless of whether the training utterance belongs to non-synthetic speech or alignment outputs.

Lastly, the training process 300 may combine the unpaired data loss function ( [symbol] _{unpaired}), the paired data loss function (J paired), and the consistent loss term ( [symbol] _{cons}) to obtain an overall loss term, [symbol] ₜₜₛ₄ₚᵣₑₜᵣₐᵢₙ₂, that may be expressed as follows.

$${𝒥}_{tts 4 pretrain 2} = {𝒥}_{unpaired} + {λ}_{1} 𝒥 paired + {λ}_{2} {𝒥}_{cons} \qquad ( 9 )$$

where λ₁ may be equal to 1.0 and λ₂ is equal to 0.1. The training process 300 may pre-train the audio encoder 210 using the overall loss term, [symbol] ₜₜₛ₄ₚᵣₑₜᵣₐᵢₙ₂, by updating parameters of the audio encoder 210 to effectively teach the audio encoder 210 to learn shared representations between speech and text in the target language even though no labeled training data in the target language is available. After training the audio encoder 210, the training process 300 may fine-tune the pre-trained audio encoder on the labeled speech utterances that may include supervised training samples of both alignment outputs corresponding to unspoken textual utterance 320 and non-synthetic (e.g., human speech).

In some implementations, the training process 300 for training the audio encoder 210 applies encoder consistency regularization. Unlike decoder consistency regularization applied to auxiliary decoder(s) during the consistency regularization part 300c that requires hypothesized labels (e.g., transcripts 302 and unspoken textual utterances 320), encoder consistency regularization does not require hypothesized labels and therefore has the advantage being allowed to be applied to all the training data 307, 306, 320. Encoder consistency regularization may be applied via Hierarchical Contrastive consistency Regularization (HCCR) techniques where encoder activations e, e* from original/non-augmented and augmented speech are projected through an auxiliary network to generate z and z*. Thereafter, positive and negative pairs are constructive and a contrastive loss l_{t,z,z*} is calculated as follows:

$${l}_{t , z , {z}^{*}} = - log \frac{exp ( sim ( {z}_{t}^{*} , {z}_{t} ) / τ )}{{\sum }_{k = 1}^{T} exp ( sim ( {z}_{t}^{*} , {z}_{k} ) / τ )} \qquad ( 10 )$$

Specific to HCCR, a Convolutional Neural Network (CNN) projection network may calculate projections over increasing length segments of encoder activations e (30, 50, 120 ms) to yield 3 views (V) and draw negative examples from the same utterance for short segments, and from other utterances in the batches with 120 ms segments. Accordingly, an HCCR loss may be calculated over the labeled speech utterances 307 (paired speech), the un-transcribed non-synthetic speech utterances 306 (unpaired speech), and the alignment outputs 402 generated from the unspoken textual utterances 320 as follows:

$${ℒ}_{enc \_ cons} = {\sum }_{v = 1}^{V} {\sum }_{t = 1}^{{T}^{( v )}} {l}_{t , {z}^{* ( v )} , {z}^{( v )}} \qquad ( 11 )$$

The HCCR loss calculated by Equation 11 may be added to Equation 9 with a coefficient of 1e-3 as part of the overall loss term, [symbol] ₜₜₛ₄ₚᵣₑₜᵣₐᵢₙ₂, for use in pre-training the audio encoder 210.

In some implementations, the training process 300 may be employed to train end-to-end ASR models with decoder structures (i.e., non-pre-training) or fine-tune an ASR model to perform downstream tasks such as speech translation or natural language understanding. Moreover, implementations described above describe the training process using each part 300a-c of the training process 300. Yet, it is understood any combination of the training parts 300a-c may be used to train the audio encoder 210 using any combination of unspoken textual utterances 320, labeled speech utterances 307, and/or untranscribed non-synthetic speech utterances 306 independently.

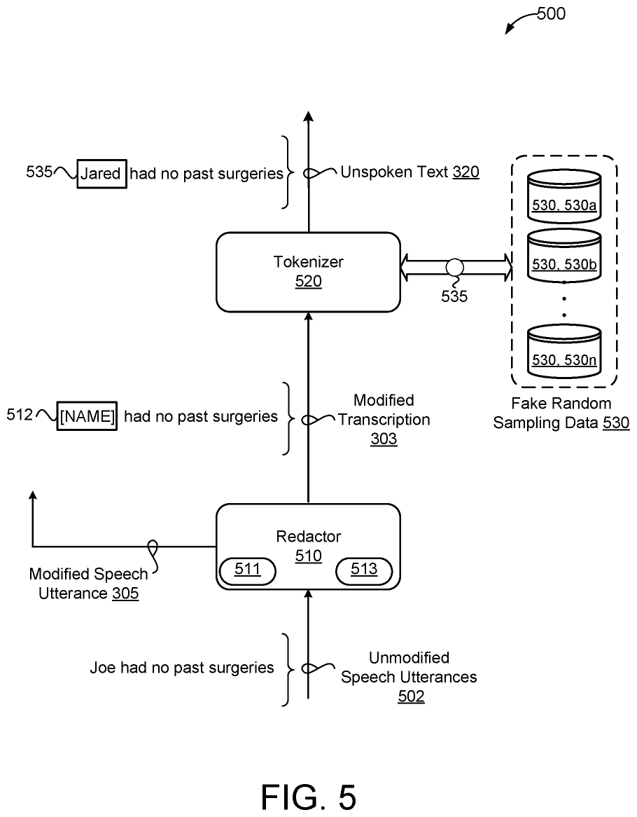

FIG. 5 illustrates an example training data generation process (e.g., generation process) 500 that generates the modified speech utterances 305 and the unspoken textual utterances 320 used by the training process 300 (FIGS. 3A-3C) to train the audio encoder 210. In some implementations, the training data also includes unmodified speech utterances 502 in the target domain. As will become apparent, the generation process 500 generates the modified speech utterances 305 and the unspoken textual utterances 320 from the unmodified speech utterances 502. In contrast to the modified speech utterances 305, the unmodified speech utterances 502 have not been modified to obfuscate one or more classes of sensitive information recited in the utterances. Simply put, the unmodified speech utterances 502 include utterances spoken in the target domain and non-redacted sensitive information. Notably, due to the sensitive information in the unmodified speech utterances 502, the training process 300 (FIGS. 3A-3C) may be unable to directly use the unmodified speech utterances 502 for various ethical and legal concerns.

In some examples, each unmodified speech utterance 502 is paired with an unmodified transcription representing the unmodified speech utterance 502 (e.g., including the sensitive information). In other examples, each unmodified speech utterance 502 is not paired with any corresponding transcription such that the unmodified speech utterances 502 include audio-only data. The target domain may be any speech-related domain that includes entity-identifying information, private information, and/or where ethical use of the sensitive information requires special care. Utterances within the target domain may include a mixture of non-sensitive information and one or more classes of sensitive information. For example, the one or more classes of sensitive information may include at least one of personally identifiable information (PII), protected health information (PHI), medical records, financial records, or dates. The non-sensitive information includes information that can be publicly known and is spoken in conjunction with the sensitive information. For instance, the unmodified speech utterance 502 of “John was admitted” includes the sensitive information of “John” and the non-sensitive information of “was admitted.”

In some implementations, the generation process 500 includes a redactor 510 and a tokenizer 520. The redactor 510 is configured to process each unmodified speech utterance 502 in the training data and generate a corresponding modified speech utterance 305 and a corresponding modified transcription 303. Since some portions of the unmodified speech utterances 502 include sensitive information, the redactor 510 identifies the sensitive information (if any) included in each unmodified speech utterance 502 and redacts the identified sensitive information. For instance, in some implementations, the redactor 510 generates each modified speech utterance 305 by replacing the identified sensitive information with silent audio data to redact the audio data associated with the sensitive information. In other implementations, the redactor 510 generates each modified speech utterance 305 by synthesizing speech corresponding to the identified sensitive information and replacing the audio data associated with the identified sensitive information with the synthesized speech. The synthesized speech may include information that is different from, but associated with, the identified sensitive information such that the synthesized speech does not reveal the actual sensitive information. Accordingly, the redactor 510 may optionally include a trained text-to-speech (TTS) or voice conversion model 511.

Continuing with the above example, for the unmodified speech utterance 502 of “John was admitted”, the redactor 510 identifies “John” as sensitive information and samples a random fake name such as “Bill” and synthesizes the sampled random fake name instead of the actual name. Thereafter, the redactor 510 replaces audio data associated with “John” with synthesized audio data associated with “Bill.” Thus, in this example, the modified speech utterance 305 includes “Bill was admitted” where the term “Bill” is synthesized speech while the rest of the utterance is non-synthetic speech.

The redactor 510 also generates a corresponding modified transcription 303 for each unmodified speech utterance 502. Thus, the modified transcriptions 303 correspond to the modified speech utterances 305. As such, the redactor 510 may include a trained ASR model 513 configured to transcribe each unmodified speech utterance 302. Notably, the redactor 510 replaces text associated with identified sensitive information with corresponding class identifiers (e.g., markup tags) 512. That is, rather than generating text representing the sensitive information, the redactor 510 inserts class identifiers 512 in place of text representing the sensitive information thereby effectively redacting or obfuscating the sensitive information. Stated differently, the redactor 510 tags the redacted portions of the transcriptions 303 of the modified speech utterances 305 with the class identifier 512. In some examples, each class identifier 512 indicates a particular class from the one or more classes of sensitive information that has been redacted. Classification identifiers 512 may indicate that the redacted text corresponds to a patient name, a date or time, a medical record, etc. For example, a respective classification identifier 512 for text representing a patient name may be “[PATIENT_NAME]” rather than text representing the actual name of the patient. Thus, the redactor 510 may classify the identified sensitive information and generate the classification identifier 512, which indicates the particular class of the sensitive information, based on the classification.

The tokenizer 520 is configured to receive, as input, each modified transcription 303 and generate, as output, corresponding unspoken textual utterances 320. In short, the tokenizer 520 inserts fake random sampling data 535 into each redacted portion of the transcriptions 303 of the modified speech utterances 305. The inserted fake random sampling data 535 is associated with the class of sensitive information identified by the class identifier tag 512 at the redacted portion. More specifically, for each modified transcription 303, the tokenizer 520 obtains corresponding fake random sampling data 535 from a database of fake random sampling data 530. The database of fake random sampling data 530, 530a-n may include a respective database of fake random sampling data 530 for each potential class identifier 512. That is, each respective database of fake random sampling data 530 includes a random distribution of data corresponding to one of the class identifiers 512. The particular class identifier 512 serves to indicate to the tokenizer 520 which respective database of fake random sampling data 530 to sample from. For example, a respective database of fake random sampling data 530 corresponding to a name class identifier 512 includes a random distribution of names (e.g., Mark, Matt, Adam, etc.).

Accordingly, the tokenizer 520 obtains corresponding fake random sampling data 535 for each respective modified transcription 303 based on the class identifiers 512 included in the respective modified transcription 303. Thereafter, the tokenizer 520 replaces the class identifiers 512 with the obtained fake random sampling data 535 associated with the class identifier 512. In some examples, the tokenizer 520 samples multiple instances of fake random sampling data 535 for a single particular class identifier 512. In these examples, the tokenizer replaces the particular class identifier 512 with each instance of fake random sampling data 535 such that the tokenizer 520 generates multiple unspoken textual utterances 320 from a single modified transcription 303.

In the example shown, the redactor 510 receives an unmodified speech utterance 502 of “Joe had no past surgeries” where “Joe” represents sensitive information and the rest of the utterance represents non-sensitive information. The redactor 510 generates a modified speech utterance 305 and a modified transcription 303 based on the unmodified speech utterance 502. The redactor 510 generates the modified speech utterance 305 by replacing audio data associated with “Joe” with silence audio data or synthesizing speech using another name (e.g., Jared) and replacing the audio data associated with “Joe” with the synthesized speech. Moreover, the redactor 510 generates the modified transcription 303 by identifying the sensitive information of “Joe,” classifying the sensitive information as a name, and replacing the identified sensitive information with the class identifier 512 indicating that the sensitive information corresponds to a name. As such, the modified transcription 303 results in “[NAME] had no past surgeries.”

Subsequently, the tokenizer 520 receives the modified transcription 303 and obtains fake random sampling data 535 by sampling data associated with the particular class identifier 512 (e.g., names) and replaces the particular class identifier 512 with the fake random sampling data 535. Here, since the particular class identifier 512 represents a name, the tokenizer 520 samples data from a random distribution of fake names and inserts the fake random sampling data 535 in place of the particular class identifier 512 resulting in the unspoken textual utterance 320 of “Jared had no past surgeries.” Notably, the unspoken textual utterance 320 does not reveal the sensitive information from the unmodified speech utterance 502. Yet, the fake random sampling data 535 is closely related to the sensitive information such that, by using the unspoken textual utterances 320 to train the ASR model 200, the ASR model 200 will be able to accurately recognize phrases within the one or more classes of sensitive information.

Advantageously, the generation process 500 receives unmodified speech utterances 502 that include sensitive information and outputs unspoken textual utterances 320 that replace the sensitive information with fake random sampling data 535. Training on the unspoken textual utterances 320 teaches the ASR model 200 to recognize speech in the target domain. Moreover, the fake random sampling data 535 inserted into the unspoken textual utterances 320 teaches the ASR model 200 to recognize terms or phrases within the one or more classes of sensitive information without training the ASR model 200 directly on the sensitive information included in the unmodified speech utterances 502. The training process 300 (FIGS. 3A-3C), uses the text-only of the unspoken textual utterances 320 to train the ASR model 200 without synthesizing the unspoken textual utterances 320.

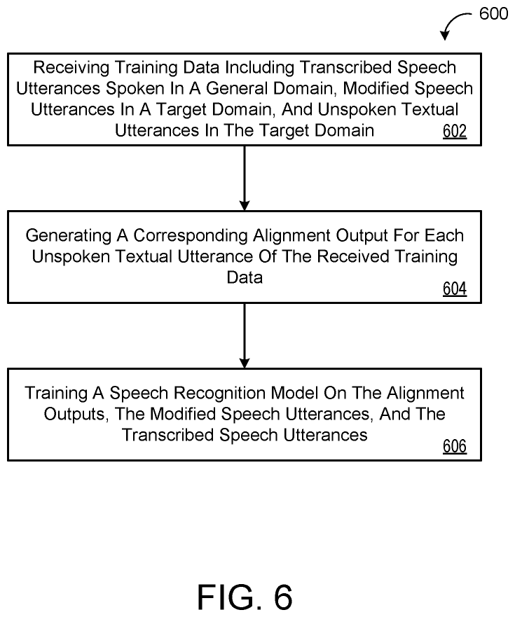

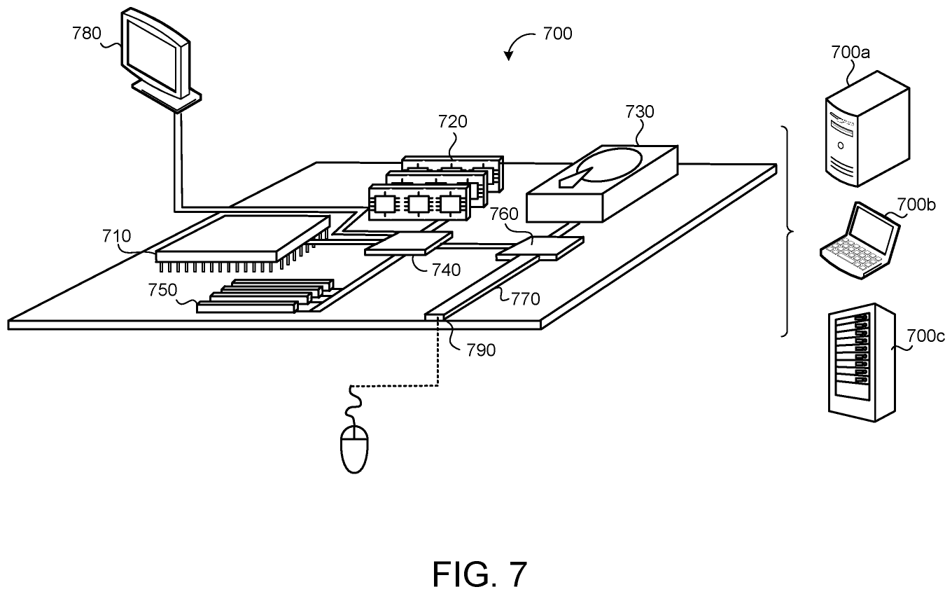

FIG. 6 is a flowchart of an example arrangement of operations for a computer-implemented method 600 of training a speech recognition model using text-injection. The method 600 may execute on data processing hardware 710 (FIG. 7) using instructions stored on memory hardware 720 (FIG. 7). The data processing hardware 710 and the memory hardware 720 may reside on the remote computing device 201 and/or the user device 102 of FIG. 1 each corresponding to a computing device 700 (FIG. 7).

At operation 602, the method 600 includes receiving training data including transcribed speech utterance 304 spoken in a general domain, modified speech utterances 305 in a target domain, and unspoken textual utterances 320. Each transcribed speech utterance 304 is paired with a corresponding transcription 302. The modified speech utterances 305 include utterances spoken in the target domain that have been modified to obfuscate one or more classes of sensitive information recited in the utterances. Moreover, each modified speech utterance 305 is paired with a corresponding transcription 303 that redacts the sensitive information obfuscated from the modified speech utterance 305. The unspoken textual utterances 320 correspond to the transcriptions of the modified speech utterances 205 in the target domain. The unspoken textual utterances 320 include fake random data 535 inserted into redacted portions of the transcriptions 303 of the modified speech utterances 305 where the sensitive information recited in the modified speech utterance has been redacted. At operation 604, the method 600 includes generating, using an alignment model 400, a corresponding alignment output 402 for each unspoken textual utterance 320 of the received training data. At operation 606, the method 600 includes training a speech recognition model 200 on the alignment outputs 402 generated for the unspoken textual utterances 320, the modified speech utterances 305, and the transcribed speech utterances 304 to teach the speech recognition model 200 to learn to recognize speech in the target domain and phrases within the one or more classes of sensitive information.

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed on data processing hardware causes the data processing hardware to perform operations comprising:
receiving training data comprising:
transcribed speech utterances spoken in a general domain, each transcribed speech utterance paired with a corresponding transcription;
modified speech utterances in a target domain, the modified speech utterances comprising utterances spoken in the target domain that have been modified to obfuscate one or more classes of sensitive information recited in the utterances, each modified speech utterance paired with a corresponding transcription that redacts the sensitive information obfuscated from the modified speech utterance; and
unspoken textual utterances corresponding to the transcriptions of the modified speech utterances in the target domain, the unspoken textual utterances comprising fake random data inserted into redacted portions of the transcriptions of the modified speech utterances where the sensitive information recited in the modified speech utterance has been redacted;
generating, using an alignment model, a corresponding alignment output for each unspoken textual utterance of the received training data; and
training a speech recognition model on the transcribed speech utterances, the modified speech utterances, and the alignment outputs generated for the unspoken textual utterances to teach the speech recognition model to learn to recognize speech in the target domain and phrases within the one or more classes of sensitive information.

2. The method of claim 1, wherein the one or more classes of sensitive information comprises at least one of personably identifiable information, protected health information, or dates.

3. The method of claim 1, wherein the redacted portions of the transcriptions of the modified speech utterances are tagged with a class identifier identifying the class of sensitive information that has been redacted.

4. The method of claim 3, wherein the fake random data inserted into each redacted portion of the transcriptions of the modified speech utterances is associated with the class of sensitive information identified by the class identifier at the redacted portion.

5. The method of claim 1, wherein the transcribed speech utterances in the general domain comprise a greater number of hours of speech than the modified speech utterances.

6. The method of claim 1, wherein the speech recognition model comprises an audio encoder and a decoder, the audio encoder comprising a stack of self-attention layers each including a multi-headed self-attention mechanism.

7. The method of claim 6, wherein the training data further comprises un-transcribed speech utterances spoken in the general domain, each un-transcribed speech utterance not paired with any corresponding transcription.

8. The method of claim 7, wherein training the speech recognition model comprises:
for each un-transcribed speech utterance:
generating a corresponding encoded representation of the un-transcribed utterance; and
training the audio encoder on a contrastive loss applied on the corresponding encoded representation of the un-transcribed speech utterance;
for each alignment output:
generating a corresponding encoded representation of the alignment output; and
training the audio encoder on a contrastive loss applied on the corresponding encoded representation of the alignment output; and
for each transcribed speech utterance:
generating a corresponding encoded representation of the transcribed speech utterance; and
training the audio encoder on a contrastive loss applied on the corresponding encoded representation of the transcribed speech utterance.

9. The method of claim 6, wherein the decoder comprises one of a Connection Temporal Classification (CTC) decoder, a Listen Attend Spell (LAS) decoder, or Recurrent Neural Network-Transducer (RNN-T) decoder.

10. The method of claim 1, wherein generating the corresponding alignment output for each unspoken textual utterance of the received training data comprises:
extracting an initial textual representation from the unspoken textual utterance;
predicting a text chunk duration for each text chunk in the unspoken textual utterance; and
upsampling the initial textual representation using the predicted text chunk duration for each text chunk in the unspoken textual utterance.

11. A system comprising:
data processing hardware; and
memory hardware in communication with the data processing hardware, the memory hardware storing instructions that when executed on the data processing hardware cause the data processing hardware to perform operations comprising:
receiving training data comprising:
transcribed speech utterances spoken in a general domain, each transcribed speech utterance paired with a corresponding transcription;
modified speech utterances in a target domain, the modified speech utterances comprising utterances spoken in the target domain that have been modified to obfuscate one or more classes of sensitive information recited in the utterances, each modified speech utterance paired with a corresponding transcription that redacts the sensitive information obfuscated from the modified speech utterance; and
unspoken textual utterances corresponding to the transcriptions of the modified speech utterances in the target domain, the unspoken textual utterances comprising fake random data inserted into redacted portions of the transcriptions of the modified speech utterances where the sensitive information recited in the modified speech utterance has been redacted;
generating, using an alignment model, a corresponding alignment output for each unspoken textual utterance of the received training data; and
training a speech recognition model on the transcribed speech utterances, the modified speech utterances, and the alignment outputs generated for the unspoken textual utterances to teach the speech recognition model to learn to recognize speech in the target domain and phrases within the one or more classes of sensitive information.

12. The system of claim 11, wherein the one or more classes of sensitive information comprises at least one of personably identifiable information, protected health information, or dates.

13. The system of claim 11, wherein the redacted portions of the transcriptions of the modified speech utterances are tagged with a class identifier identifying the class of sensitive information that has been redacted.

14. The system of claim 13, wherein the fake random data inserted into each redacted portion of the transcriptions of the modified speech utterances is associated with the class of sensitive information identified by the class identifier at the redacted portion.

15. The system of claim 11, wherein the transcribed speech utterances in the general domain comprise a greater number of hours of speech than the modified speech utterances.

16. The system of claim 11, wherein the speech recognition model comprises an audio encoder and a decoder, the audio encoder comprising a stack of self-attention layers each including a multi-headed self-attention mechanism.

17. The system of claim 16, wherein the training data further comprises un-transcribed speech utterances spoken in the general domain, each un-transcribed speech utterance not paired with any corresponding transcription.

18. The system of claim 17, wherein training the speech recognition model comprises:
for each un-transcribed speech utterance:
generating a corresponding encoded representation of the un-transcribed utterance; and
training the audio encoder on a contrastive loss applied on the corresponding encoded representation of the un-transcribed speech utterance;
for each alignment output:
generating a corresponding encoded representation of the alignment output; and
training the audio encoder on a contrastive loss applied on the corresponding encoded representation of the alignment output; and
for each transcribed speech utterance:
generating a corresponding encoded representation of the transcribed speech utterance; and
training the audio encoder on a contrastive loss applied on the corresponding encoded representation of the transcribed speech utterance.

19. The system of claim 16, wherein the decoder comprises one of a Connection Temporal Classification (CTC) decoder, a Listen Attend Spell (LAS) decoder, or Recurrent Neural Network-Transducer (RNN-T) decoder.

20. The system of claim 11, wherein generating the corresponding alignment output for each unspoken textual utterance of the received training data comprises:
extracting an initial textual representation from the unspoken textual utterance;
predicting a text chunk duration for each text chunk in the unspoken textual utterance; and
upsampling the initial textual representation using the predicted text chunk duration for each text chunk in the unspoken textual utterance.
